(19) United States
(12) Patent Application Publication
(10) Pub. No.: US 2024/0370262 A1
(43) Pub. Date: Nov. 7, 2024

(54) COMPUTING DEVICE AND METHOD OF SCHEDULING FOR EXECUTING PLURALITY OF THREADS

(71) Applicant: SAMSUNG ELECTRONICS CO., LTD., Suwon-si (KR)

(72) Inventors: Seho Kim, Suwon-si (KR); Minji Park, Suwon-si (KR); Jihun Ham, Suwon-si (KR); Hyungjoon Park, Suwon-si (KR); Jinho Yi, Suwon-si (KR)

(73) Assignee: SAMSUNG ELECTRONICS CO., LTD., Suwon-si (KR)

(21) Appl. No.: 18/631,461

(22) Filed: Apr. 10, 2024

(30) Foreign Application Priority Data
May 2, 2023 (KR) 10-2023-0057267

(51) Int. Cl. G06F 9/30; G06F 9/48

(52) U.S. Cl. CPC G06F 9/3009; G06F 9/4881

(57) ABSTRACT

A computing device is provided. The computing device includes: a memory configured to load an application program including a plurality of threads; a processor configured to concurrently execute threads that are in a first state, and to convert a thread, which completes processing of at least one task distributed among the plurality of threads, from among the plurality of threads, from the first state into a second state, wherein the first state corresponds to an activated state in which a thread processes the at least one task, and the second state corresponds to a wait state; and a thread management processor configured to set all of the plurality of threads to the first state based on all of the plurality of threads being in the second state.

### CROSS-REFERENCE TO RELATED APPLICATION

This application claims priority to Korean Patent Application No. 10-2023-0057267, filed on May 2, 2023, in the Korean Intellectual Property Office, the disclosure of which is incorporated by reference herein in its entirety.

### BACKGROUND

The present disclosure relates to a computing device, and more particularly, relate to a computing device and a scheduling method for executing a plurality of threads.

A thread is a basic unit of processor utilization. An application program may have a single-thread structure executed through one thread or a multi-thread structure that supports parallel execution of a plurality of threads. An application program having the multi-thread structure may perform one task and may simultaneously perform at least two tasks by executing the plurality of threads in parallel. Because the multi-thread structure may improve user responsiveness and may share resources by sharing a common area of a memory, the application program of the multi-thread structure is more efficient than an application program of the single-thread.

Due to intervention of an operating system, the application program of the multi-thread structure is limited to controlling an operation of each of the plurality of threads. As the number of threads increases, the reproducibility of an operation of an application program deteriorates.

In a case of an application program, such as a simulator, in which the reproducibility needs to be guaranteed, it is difficult to analyze and solve simulation results because the reproducibility is not guaranteed. A method for increasing reproducibility when an application program is executed is required.

### SUMMARY

Embodiments provide a computing device and a scheduling method for executing a plurality of threads that guarantee reproducibility in an application program of a multi-thread structure.

According to an aspect of an embodiment, a computing device includes: a memory configured to load an application program including a plurality of threads; a processor configured to concurrently execute threads that are in a first state, and to convert a thread, which completes processing of at least one task distributed among the plurality of threads, from among the plurality of threads, from the first state into a second state, wherein the first state corresponds to an activated state in which a thread processes the at least one task, and the second state corresponds to a wait state; and a thread management processor configured to set all of the plurality of threads to the first state based on all of the plurality of threads being in the second state.

According to an aspect of an embodiment, a computing device includes: a memory configured to load an application including a main thread and a plurality of threads; and a processor configured to concurrently execute threads that are in a first state, and to convert a thread, which completes processing of at least one task distributed among the plurality of threads, from among the plurality of threads, from the first state into a second state, wherein the first state corresponds to an activated state in which a thread processes at least one task, and the second state corresponds to a wait state. The processor is further configured to control the main thread to convert all of the plurality of threads to the first state based on all of the plurality of threads being in the second state.

According to an aspect of an embodiment, a method includes: executing a thread in a first state among a plurality of threads included in an application program, wherein the first state corresponds to an activated state in which a thread processes at least one task distributed among the plurality of threads; converting the thread from the first state into a second state based on the thread completing processing of at least one distributed task, wherein the second state corresponds to a wait state; and setting all of the plurality of threads to the first state based on all of the plurality of threads being in the second state.

### BRIEF DESCRIPTION OF DRAWINGS

The above and other aspects and features will be more clearly understood from the following description of embodiments, taken in conjunction with the accompanying drawings.

FIG. 1 is a block diagram illustrating a computing device, according to an embodiment.

FIG. 2 is a diagram for describing an operation of the thread management handler of FIG. 1.

FIG. 3 is a diagram showing states of threads, according to an embodiment.

FIG. 4 is a diagram illustrating an operation of a plurality of threads, according to an embodiment.

FIGS. 5A, 5B and 5C are diagrams illustrating a state of each of a plurality of threads and tasks stored in a plurality of task queues depending on an operation of a thread, according to an embodiment.

FIG. 6 is a diagram illustrating a plurality of task queues, according to an embodiment.

FIG. 7 is a diagram illustrating a sequence of executing tasks inserted into a task queue corresponding to a thread, according to an embodiment.

FIG. 8 is a diagram illustrating an operation, in which each of a plurality of threads records task information of a task processed in a task log area, according to an embodiment.

FIGS. 9A and 9B are diagrams illustrating a target system and a target system simulator, according to an embodiment.

FIG. 10 is a diagram showing threads included in an application program, according to an embodiment.

FIG. 11 is a diagram illustrating a computing device.

FIG. 12 is a flowchart illustrating a method for scheduling a plurality of threads, according to an embodiment.

### DETAILED DESCRIPTION

Hereinafter, embodiments will be described with reference to the accompanying drawings. Embodiments described herein are provided as examples, and thus, the present disclosure is not limited thereto, and may be realized in various other forms. Each embodiment provided in the following description is not excluded from being associated with one or more features of another example or another embodiment also provided herein or not provided herein but consistent with the present disclosure.

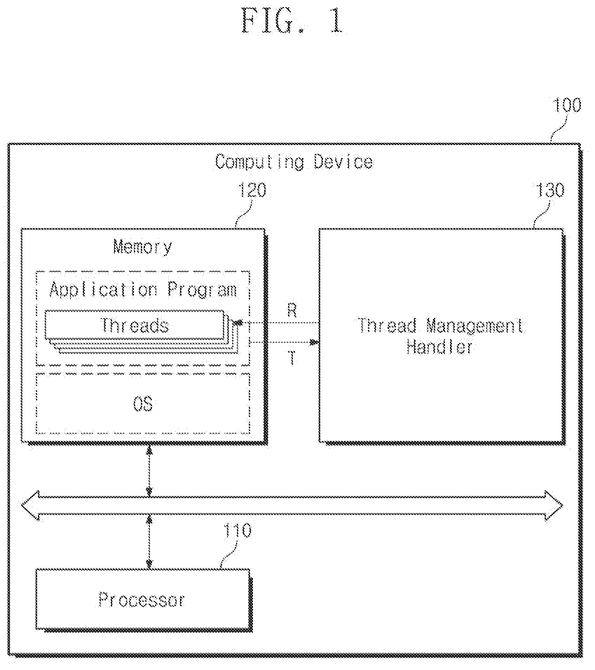

FIG. 1 is a block diagram illustrating a computing device, according to an embodiment. Referring to FIG. 1, a computing device 100 may include a processor 110, a memory 120, and a thread management handler 130 (e.g., a thread management processor).

The processor 110 may control overall operations of the computing device 100 and may perform a logical operation. The processor 110 may be a System-on-Chip (SoC), a general purpose processor, a special purpose processor, or an application processor. The processor 110 may execute an operating system OS loaded onto the memory 120. The processor 110 may execute an application program that operates based on the operating system OS. The processor 110 may include one or more cores for executing the operating system OS or an application program. When including only one core, the processor 110 may concurrently execute a plurality of threads through time slicing. When the processor 110 includes two or more cores, the processor 110 may execute a plurality of threads concurrently, for example in parallel, by respectively allocating threads to the cores.

The memory 120 may be controlled by the processor 110, and an application program and the operating system OS including a plurality of threads may be loaded onto the memory 120. The application program loaded onto the memory 120 is also referred to as a “process”, and may have a multi-thread structure that operates through the execution of a plurality of threads. The plurality of threads included in the application program is a flow of executions, and each thread may be executed concurrently by a processor. The common area of the application program may include a code area, a data area, and a heap area. Each of the plurality of threads may have a unique stack area on the unique memory 120 and may share the common area of the application program.

The operating system OS may be loaded onto the memory 120 by a booting sequence of the computing device 100. The operating system OS may allocate or release resources of the memory 120 to or from the application program. Moreover, the operating system OS allocates an uptime of the processor 110 to an application program or a plurality of threads such that the plurality of threads are executed.

Each of the plurality of threads may be managed through a thread control block. The thread control block is a data block or record that includes various pieces of information for controlling a thread, such as a thread identifier, a program counter (PC) of the thread, a stack pointer (SP) of the thread, and a state of the thread. The thread control block may be managed in a user area of the memory 120 or a kernel area of the operating system OS.

Among the plurality of threads, each thread in a run state may be executed by the processor 110 and may process a distributed task. The task is a unit of work that is processed in a thread. When completing the processing of one task, each of the plurality of threads may return at least one new task. The returned new tasks may be transmitted to the thread management handler 130. The returned new tasks may be inserted into a task queue included in the thread management handler 130 and may be distributed to one of the plurality of threads.

The thread management handler 130 may manage states of the plurality of threads. Furthermore, the thread management handler 130 may manage tasks to be processed in a thread. The thread management handler 130 may monitor the states of threads included in the thread control block. In response to each of the plurality of threads included in the application program being in a wait state, the thread management handler 130 may simultaneously set all of the plurality of threads to a run state ‘R’. The threads set to the run state may be executed by the processor 110 to process tasks distributed to the threads. The thread management handler 130 may receive a task to be processed in a thread from each of the plurality of threads. The thread management handler 130 may store tasks in a task queue. When the processing of the task is completed through the execution of the thread, the task stored in the task queue may be deleted.

In an application program having a multi-thread structure, each thread is executed concurrently by a processor and scheduled by the operating system OS. Accordingly, as the number of threads increases, the reproducibility of task processing in the application program may decrease.

A single-threaded application program is reproducible because tasks are processed sequentially on a single thread, meaning that even if the application program is executed multiple times, the tasks may be processed in a preset order. However, the single-threaded application program has limitations in implementing a multi-threaded environment. When a multi-threaded application program is executed by the processor, the tasks are processed concurrently on separate threads. When the plurality of threads process tasks, the scheduler of the operating systems OS intervenes. As a result, each time the multi-threaded application program is executed by the processor, the order in which the tasks are processed may change. As the number of threads increases, the order in which tasks are processed during the execution of the application program changes even more dramatically. While the computing device 100 according to an embodiment executes an application program, when the plurality of threads respectively process tasks to be processed, each of the plurality of threads is switched to a wait state, and the thread management handler 130 simultaneously switches all of the plurality of threads to wait states. Accordingly, when a thread processes a task, a sequential element may be added. In this way, in an application program, tasks may be processed concurrently and sequentially, and the reproducibility of task processing may be increased. Even if the application program is executed multiple times, the task may be processed in the same or similar order on each execution of the application program.

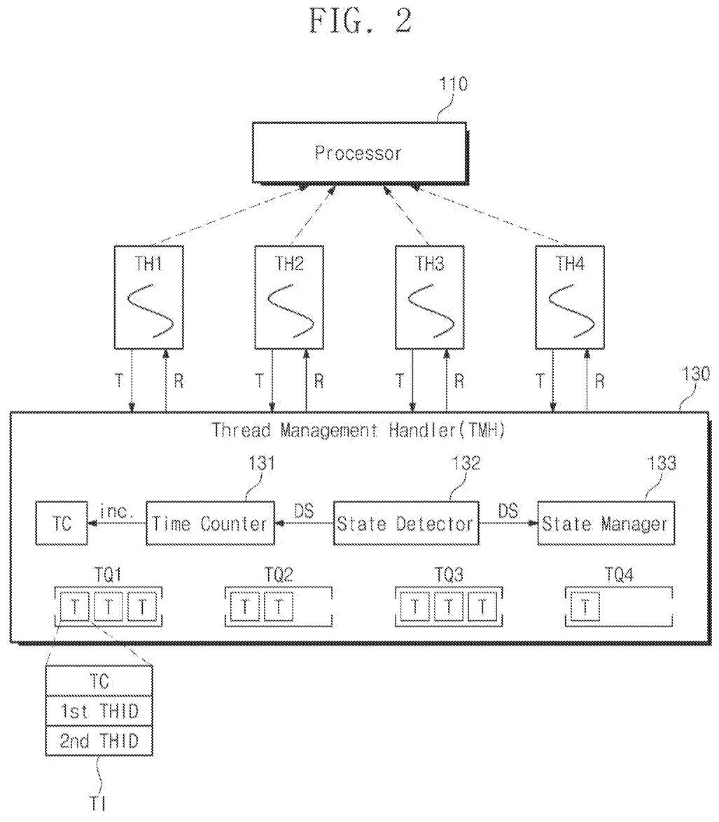

FIG. 2 is a diagram for describing an operation of the thread management handler of FIG. 1. Referring to FIG. 2, the thread management handler 130 may include a plurality of task queues TQ1, TQ2, TQ3, and TQ4, a time counter 131, a state detector 132, and a state manager 133.

Each of the plurality of task queues TQ1 to TQ4 stores at least one task ‘T’ to be processed in the corresponding thread. For example, the task queue 1 TQ1 stores tasks ‘T’ to be processed in a thread 1 TH1, and the task queue 2 TQ2 stores tasks ‘T’ to be processed in a thread 2 TH2. In a first-in-first-out (FIFO) manner, tasks ‘T’ may be inserted in or deleted from the plurality of task queues TQ1 to TQ4.

The state detector 132 may detect a state of each of the plurality of threads TH1, TH2, TH3, and TH4. Pieces of information (e.g., a thread identifier, a program counter, a stack pointer, a thread state, or the like) related to the plurality of threads TH1 to TH4 are stored in an area to which a thread control block of the memory 120 is allocated. The state detector 132 may identify the current state of the corresponding thread by monitoring the state of the thread included in each thread control block. The state detector 132 may output a detection signal DS to the state manager 133 and the time counter 131 in response to all of the plurality of threads TH1 to TH4 being in wait states.

The state manager 133 may set states of all of the plurality of threads TH1 to TH4 to state Run (R) based on the received detection signal DS. In this way, all of the plurality of threads TH1 to TH4 switch from wait states to run states. The plurality of threads TH1 to TH4 set to run states are activated to process task ‘T’. Except when access to an area of another thread is required, the activated threads TH1 to TH4 may process the task ‘T’ distributed to them without waiting for the preceding operations of other threads.

The plurality of threads TH1 to TH4 may return new task ‘T’ as the result of processing distributed task ‘T’. Tasks ‘T’ returned from the plurality of threads TH1 to TH4 are stored in the corresponding task queue among the plurality of task queues TQ1 to TQ4 of the thread management handler 130. Task ‘T’ returned from each of the plurality of threads TH1 to TH4 may include task information TI. The task information TI may include a time count TC, a first thread identifier 1st THID, and a second thread identifier 2nd THID.

The time counter 131 may increment the time count TC in response to the received detection signal DS. The time count TC is a time reference at which each of the plurality of threads TH1 to TH4 processes task ‘T’. A thread may process tasks, which correspond to the time count TC that is less than the incremented time count TC, from among the tasks stored in the corresponding task queue. The thread that has processed all tasks corresponding to the time count TC less than the incremented time count TC may be changed from a run state to a wait state by the processor 110.

The time count TC included in the task information TI may be a value of the time count TC when task ‘T’ is returned from the thread. That is, task ‘T’ having the time count TC of ‘k’ in the task information TI is returned when the time count TC of the thread management handler 130 is ‘k’. After the time count TC of the thread management handler 130 is incremented to ‘k+1’, tasks ‘T’ having the time count TC of ‘k’ (i.e., tasks having the time count TC that is less than the incremented time count TC) may be processed through the plurality of threads TH1 to TH4.

The first thread identifier 1st THID included in the task information TI is an identifier of a thread that returns task ‘T’. For example, the first thread identifier 1st THID of task ‘T’ returned from the thread 1 TH1 may be an identifier corresponding to the thread 1 TH1.

The second thread identifier 2nd THID included in the task information TI is an identifier of a thread scheduled to process task ‘T’. That is, task ‘T’ thus returned is distributed to a thread corresponding to the second thread identifier 2nd THID. For example, the second thread identifier 2nd THID of task ‘T’, which is scheduled to be processed in the thread 2 TH2, may be an identifier corresponding to the thread 2 TH2.

The plurality of threads TH1 to TH4 may be executed concurrently or in parallel using operation resources of the processor 110 allocated through the operating system OS.

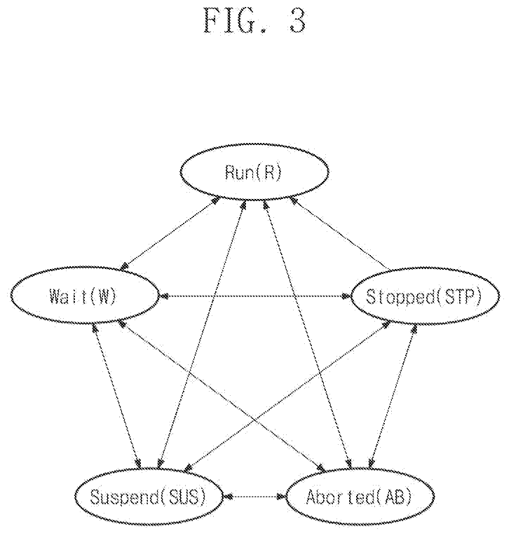

FIG. 3 is a diagram showing states of threads, according to an embodiment. Referring to FIG. 3, a thread may be in one state of state Run (R), state Wait (W), state Suspend (SUS), state Stopped (STP), and state Aborted (AB).

State Run (R) is a state activated to process distributed tasks. The processor 110 may concurrently execute threads having state Run (R). The threads having state Run (R) may be executed by the processor 110 and may process distributed tasks. When all of the tasks to be processed by the thread are processed, the processor 110 may convert a state of the thread from state Run (R) to state Wait (W). In this case, a state of a thread included in the thread control block may change from a value corresponding to state Run (R) to a value corresponding to state Wait (W).

State Wait (W) is a state where all tasks to be processed by the thread have been processed. A thread in state Wait (W) is maintained in the memory 120, and does not process a new task without being allocated resources of the processor 110.

State Suspend (SUS) is a state where a thread is not executed and suspended until the execution of other threads is terminated. When interference between one thread in state Run (R) and another thread occurs, the priority between threads may be determined depending on the scheduling policy of an application program or an operating system. As an example of the interference between threads, one thread may access an area of another thread. In this case, one thread having a lower priority may be switched to state Suspend (SUS) until a state of another thread having higher priority is switched to a wait state. In this case, the execution of the lower-priority thread is suspended until the execution of the higher-priority thread is completed. When the execution of the higher-priority thread is completed, the lower-priority thread may be changed to state Run (R) and may be executed through the processor 110. Another example of the interference between threads corresponds to access to a common area shared by one thread and another thread. In this case, the common area may be managed as a critical section, and a synchronization method such as semaphore may be applied. When the plurality of threads run concurrently, the plurality of threads may access shared resources (e.g. common area) at the same time. Concurrent access to shared resources may lead to unexpected or erroneous behavior. The critical section is a region that is set to be inaccessible to more than one thread at the same time. The critical section cannot be entered by more than one process or thread at a time; other threads are suspended until the previously accessed thread leaves the critical section.

State Stopped (STP) is a state entered when the execution of a thread is intentionally stopped. A thread in state Stopped (STP) needs to be changed to state Wait (W) or state Run (R) before the thread may be executed again.

State Aborted (AB) is the state entered by a thread when an unexpected fault occurs. The thread in state Aborted (AB) needs to be changed to state Wait (W) or state Run (R) before the thread may be executed again.

The state of a thread may be switched between state Run (R), state Wait (W), state Suspend (SUS), state Stopped (STP), and state Aborted (AB) depending on the policy of the application program or operating system.

For example, a thread in state Wait (W) may be changed to state Run (R) to be executed through the processor 110. When a thread in state Run (R) has completed processing of a task to be processed, the thread in state Run (R) may be changed back to state Wait (W) by the processor 110. Interference may occur between a thread that is in state Run (R) and another thread, a thread determined to have a lower priority according to a policy may be switched from state Run (R) to state Suspend (SUS). When an unexpected fault occurs while a thread in state Run (R) is running through the processor 110, a thread in state Run (R) may be changed to state Aborted (AB). When a thread in state Run (R) intentionally stops running, a thread in state Run (R) may be changed to state Stopped (STP).

When the execution of a higher-priority thread is completed, a thread in state Suspend (SUS) may be switched to state Run (R), and then may be executed through the processor 110. When an unexpected fault occurs, the thread in state Suspend (SUS) may be changed to state Aborted (AB). When a thread in state Suspend (SUS) intentionally stops running, the thread in state Suspend (SUS) may be changed to state Stopped (STP).

A state of each of a plurality of threads may be managed through a thread control block. When a thread transitions from state Wait (W) to state Run (R), the state of a thread included in the thread control block may be changed from a value corresponding to state Wait (W) to a value corresponding to state Run (R).

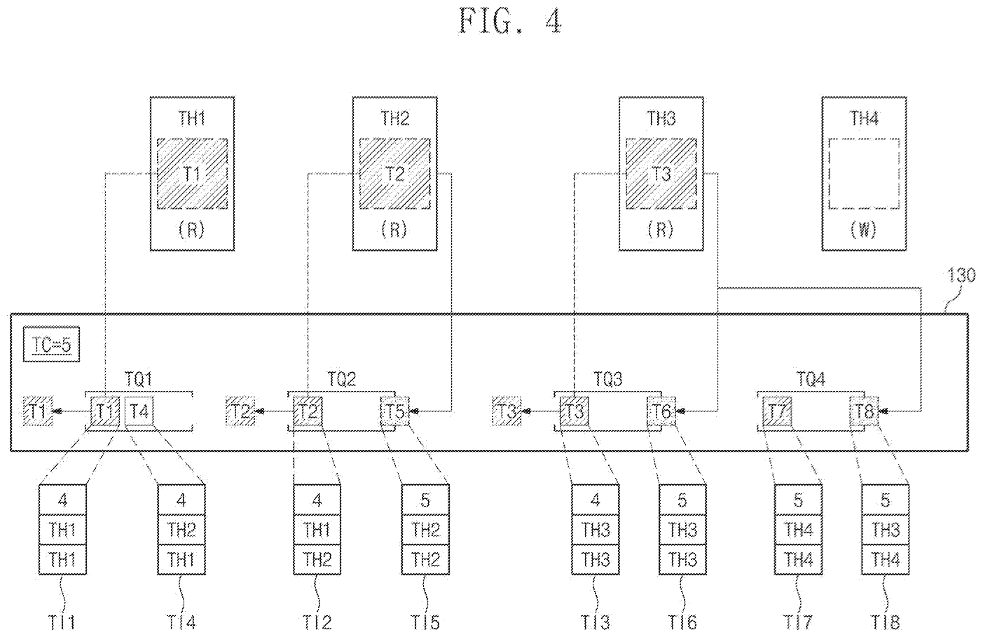

FIG. 4 is a diagram illustrating an operation of a plurality of threads, according to an embodiment. Referring to FIG. 4, each of the plurality of threads TH1 to TH4 may process tasks having the time count TC less than the incremented time count TC among tasks included in the corresponding plurality of task queues TQ1 to TQ4.

Each of the plurality of task queues TQ1, TQ2, TQ3, and TQ4 may store at least one task to be processed in corresponding threads TH1 to TH4. For example, the task queue 1 TQ1 may store a task 1 T1 and a task 4 T4 to be processed in the thread 1 TH1. The task queue 2 TQ2 may store a task 2 T2 to be processed in the thread 2 TH2. A task queue 3 TQ3 may store a task 3 T3 to be processed in the thread 3 TH3. A task queue 4 TQ4 may store a task 7 T7 to be processed in the thread 4 TH4. In this case, the time count TC of the task 1 T1 to the task 4 T4 is 4. That is, the task 1 T1 to the task 4 T4 are tasks returned when the time count TC of the thread management handler 130 is 4. The task 7 T7 stored in the task queue 4 TQ4 is a task returned when the time count TC is 5.

A thread in state Run (R) may process a task having the time count TC less than the incremented time count TC. After processing the task, a thread in state Run (R) may return a task to be processed in one thread among the plurality of threads TH1 to TH4.

The task may be of one of two types: a first type in which a succeeding task is returned, and a second type in which no subsequent task is returned. When a task of the first type is processed by a thread, one or more new subsequent tasks may be returned. The returned task may be inserted into the task queue that corresponds to the thread that is determined to process the task among a plurality of task queues. If the second type of task is processed by a thread, no new task is returned. For example, the thread 1 TH1 may process the task 1 T1 stored in the task queue 1 TQ1. Task1 T1 may be of the second type. There is no need for a task to be processed after the task 1 T1 is processed. After processing the task 1 T1, the thread 1 TH1 does not return the subsequent task. When processing of the task 1 T1 is completed, the task 1 T1 may be deleted from the task queue 1 TQ1. The thread 1 TH1 may be maintained in state Run (R) and may process the task 4 T4 having the time count TC of 4.

The thread 2 TH2 may process the task 2 T2 stored in the task queue 2 TQ2. Task2 T2 may be of the first type. After processing the task 2 T2, processing of a task 5 T5 may be required in the thread 2 TH2. After processing the task 2 T2, the thread 2 TH2 may return the subsequent task 5 T5. The returned task 5 T5 may be inserted into the task queue 2 TQ2. In this case, the time count TC of the task 5 T5 is 5. When processing of the task 2 T2 is completed, the task 2 T2 may be deleted from the task queue 2 TQ2. After the processing of the task 2 T2, there is no task having the time count TC less than 5 corresponding to the current time count TC in the task queue 2 TQ2. Accordingly, the thread 2 TH2 is switched from state Run (R) to state Wait (W).

The thread 3 TH3 may process the task 3 T3 stored in the task queue 3 TQ3. Task3 T3 may be of the second type. After the task 3 T3 is processed, the thread 3 TH3 may need to process a task 6 T6, and the thread 4 TH4 may need to process the task 8 T8. After processing the task 3 T3, the thread 3 TH3 may return the subsequent task 6 T6 and a subsequent task 8 T8. Among the returned tasks T6 and T8, the task 6 T6 may be inserted into the task queue 3 TQ3, and the task 8 T8 may be inserted into the task queue 4 TQ4. The time count TC of the task 6 T6 and the task 8 T8 has the current time count TC of 5. When processing of the task 3 T3 is completed, the task 3 T3 may be deleted from the task queue 3 TQ3. After the processing of the task 3 T3, there is no task having the time count TC less than 5 corresponding to the current time count TC in the task queue 3 TQ3. Accordingly, the thread 3 TH3 is switched from state Run (R) to state Wait (W).

The thread 4 TH4 is a thread in state Wait (W). Only the task 7 T7 having the time count TC corresponding to the current time count TC of 5 is stored in the task queue 4 TQ4, and there is no task having the time count TC less than 5. Accordingly, the thread 4 TH4 is not executed by the processor 110 while the time count TC is 5, but is maintained in the application program area of the memory 120.

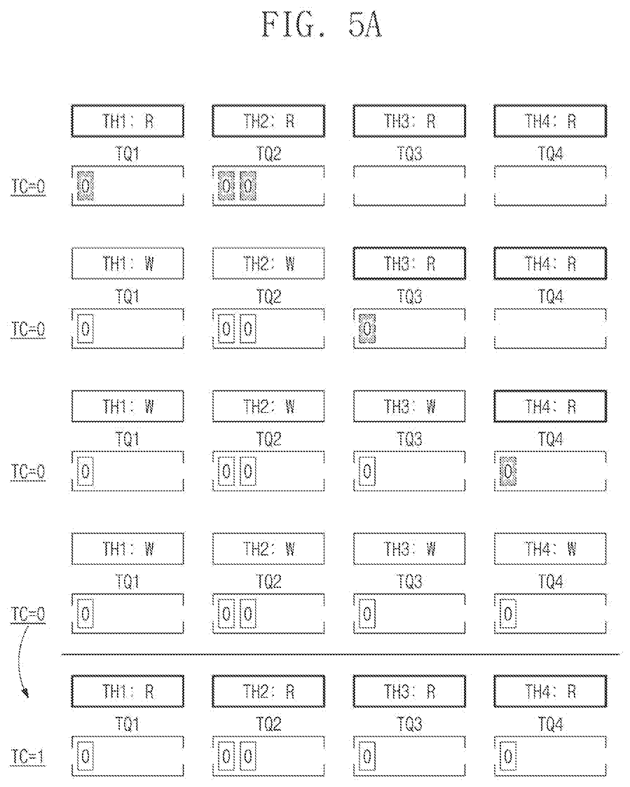

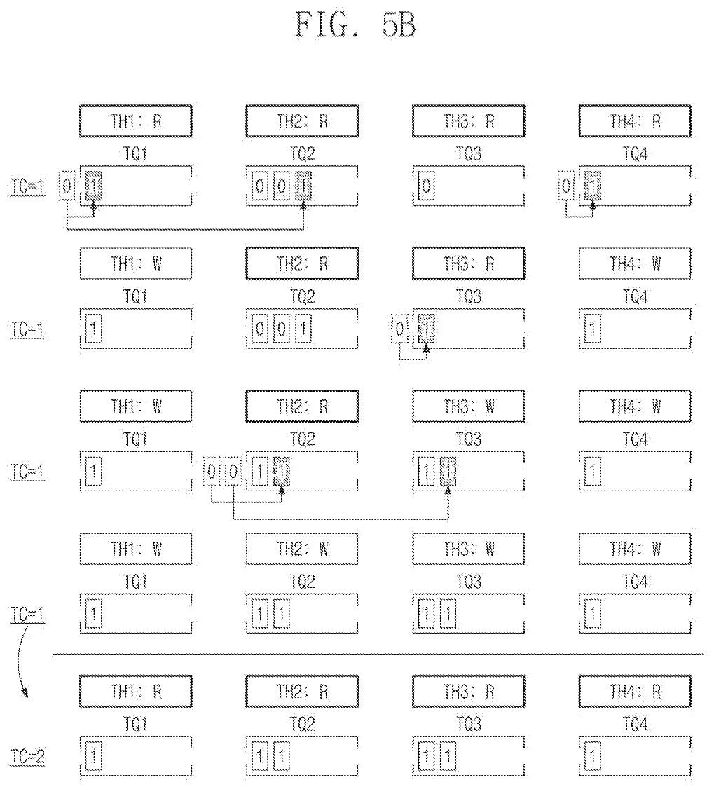

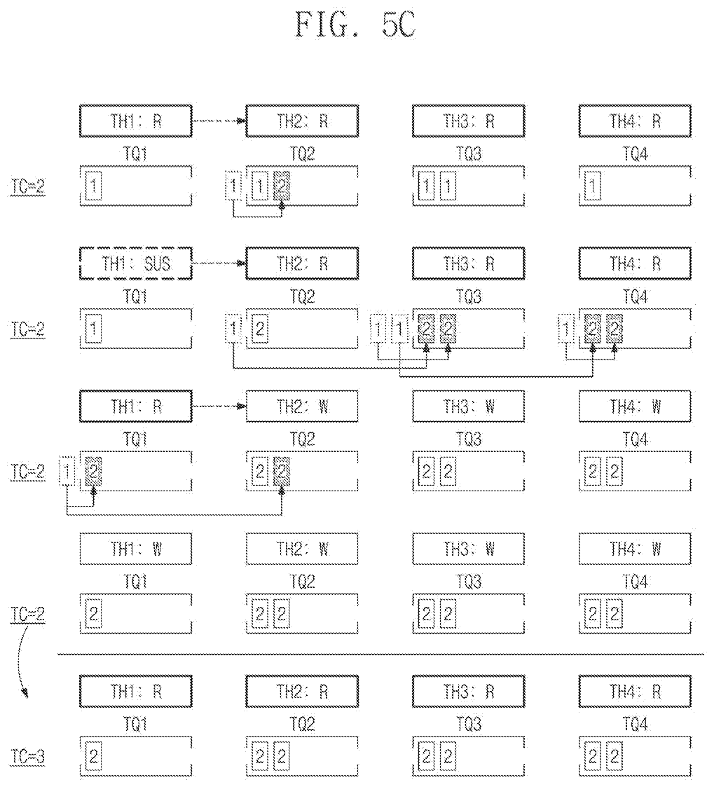

FIGS. 5A, 5B and 5C are diagrams illustrating a state of each of a plurality of threads and tasks stored in a plurality of task queues depending on an operation of a thread, according to an embodiment. Referring to FIG. 5A, the thread management handler 130 may set all of the plurality of threads TH1 to TH4 to state Run (R) in response to all of the plurality of threads TH1 to TH4 being in state Wait (W).

When an application program starts, the plurality of threads TH1 to TH4 may be generated. The thread management handler 130 may activate all of the plurality of threads TH1 to TH4 such that each of the plurality of threads TH1 to TH4 is capable of processing tasks to be processed, by setting all of the plurality of threads TH1 to TH4 to state Run (R).

Depending on the execution of the thread 1 TH1 and the thread 2 TH2, tasks having the time count TC of 0 are inserted into the task queue 1 TQ1 and the task queue 2 TQ2. The inserted tasks are annotated with shading. When the execution of tasks in the thread 1 TH1 and the thread 2 TH2 is completed, the thread 1 TH1 and the thread 2 TH2 may be switched to state Wait (W). In this case, each of the thread 1 TH1 and the thread 2 TH2 is in state Wait (W), and each of the thread 3 TH3 and the thread 4 TH4 is in state Run (R).

Depending on the execution of the thread 3 TH3, the task having the time count TC of 0 is inserted into the task queue 3 TQ3. When the execution of the thread 3 TH3 is completed, the thread 3 TH3 may be switched to state Wait (W). In this case, each of the thread 1 TH1, the thread 2 TH2 and the thread 3 TH3 is in state Wait (W), and the thread 4 TH4 is in state Run (R).

Depending on the execution of the thread 4 TH4, the task having the time count TC of 0 is inserted into the task queue 4 TQ4. When the execution of the thread 4 TH4 is completed, the thread 4 TH4 may be switched to state Wait (W). In this case, all of the plurality of threads TH1 to TH4 are in state Wait (W).

The thread management handler 130 may set the plurality of threads TH1 to TH4 to state Run (R) in response to all of the plurality of threads TH1 to TH4 being in state Wait (W). Moreover, the thread management handler 130 may increment the time count TC from 0 to 1 in response to all of the plurality of threads TH1 to TH4 being in state Wait (W).

Referring to FIG. 5B, among tasks stored in the corresponding task queue, each of the plurality of threads TH1 to TH4 may process tasks having the time count TC less than the current time count TC of 1.

As shown in FIG. 5B, all of the plurality of threads TH1 to TH4 are set to state Run (R) by the thread management handler 130.

Among one or more tasks stored in the task queue 1 TQ1, the thread 1 TH1 in state Run (R) may process a task having the time count TC less than the current time count TC of 1. The thread 1 TH1 may return two subsequent tasks after processing the task. The two returned tasks have the time count TC of 1. One of the two returned tasks is scheduled to be processed in the thread 1 TH1 and is inserted into the task queue 1 TQ1. The other task thereof is scheduled to be processed in the thread 2 TH2 and is inserted into the task queue 2 TQ2. The task processed in the thread 1 TH1 may be deleted from the task queue 1 TQ1. A diagonal line is shown to indicate the deleted task.

The thread 4 TH4 in state Run (R) may process a task, which has the time count TC less than 1, from among one or more tasks stored in the task queue 4 TQ4. The thread 4 TH4 may return a subsequent task after processing the task. The time count TC of the returned task is 1. The returned task is scheduled to be executed in the thread 4 TH4, and is inserted into the task queue 4 TQ4. The task executed in the thread 4 TH4 may be deleted from the task queue 4 TQ4.

Because all tasks having the time count TC less than 1 in the task queue 1 TQ1 and the task queue 4 TQ4 have been processed, the execution of the thread 1 TH1 and the thread 4 TH4 is completed, and each of the thread 1 TH1 and the thread 4 TH4 transitions from state Run (R) to state Wait (W).

The thread 3 TH3 may process a task, which has the time count TC less than 1, from among one or more tasks stored in the task queue 3 TQ3. The thread 3 TH3 may return a subsequent task after executing a task. The returned task has the time count TC of 1. The returned task is scheduled to be executed in the thread 3 TH3, and is inserted into the task queue 3 TQ3. The task executed in the thread 3 TH3 may be deleted from the task queue 3 TQ3. Because all tasks having the time count TC less than 1 in the task queue 3 TQ3 have been executed, the thread 3 TH3 may transition from state Run (R) to state Wait (W).

The thread 2 TH2 may process a task, which has the time count TC less than 1, from among one or more tasks stored in the task queue 2 TQ2. The thread 2 TH2 may return a subsequent task after processing the task. The returned task has the time count TC of 1. The returned task is scheduled to be processed in the thread 2 TH2, and is inserted into the task queue 2 TQ2. The task processed in the thread 2 TH2 may be deleted from the task queue 2 TQ2. The thread 2 TH2 may further process a task having a time count less than 1 among tasks stored in the task queue 2 TQ2. The thread 2 TH2 may return a subsequent task after processing the task. The returned task has the time count TC of 1. The returned task is scheduled to be processed in the thread 3 TH3, and is inserted into the task queue 3 TQ3. The task processed in the thread 2 TH2 may be deleted from the task queue 2 TQ2. Because all tasks having the time count TC less than 1 in the task queue 2 TQ2 have been processed, the thread 2 TH2 may transition from state Run (R) to state Wait (W).

The thread management handler 130 may set the plurality of threads TH1 to TH4 to state Run (R) in response to all of the plurality of threads TH1 to TH4 being in state Wait (W). The thread management handler 130 may increment the time count TC from 1 to 2 in response to all of the plurality of threads TH1 to TH4 being in state Wait (W).

Referring to FIG. 5C, each of the plurality of threads TH1 to TH4 may execute a task, which has the time count TC less than the incremented time count TC of 2, among the tasks stored in the corresponding task queue.

It is assumed that interference occurs between the thread 1 TH1 and the thread 2 TH2. As an example of interference between threads, the thread 1 TH1 may access a memory area of the thread 2 TH2. This is indicated by the arrows originating from the thread 1 TH1 and extending to the thread 2 TH2. When the thread 1 TH1 accesses the memory area of the thread 2 TH2, the thread 2 TH2 may be determined as a higher-priority thread, and the thread 1 TH1 may be determined as a lower-priority thread. For example, the determination may be made by the thread management handler 130. Alternatively, as an example of the interference between threads, the thread 1 TH1 and the thread 2 TH2 may access the same common area. In this case, the common area may be managed as a critical section. At this time, a synchronization method such as semaphore may be used such that the thread 1 TH1 or the thread 2 TH2 ensure exclusive use of the common area.

When the thread 1 TH1 being the lower-priority thread accesses the memory area of the thread 2 TH2, the thread 1 TH1 may be set to state Suspend (SUS) until the execution of the thread 2 TH2 is completed.

The thread 2 TH2 in state Run (R) may process a task, which has the time count TC less than 2, from among one or more tasks stored in the task queue 2 TQ2. The thread 2 TH2 may return a subsequent task after processing the task. The returned task has the time count TC of 2. The returned task is scheduled to be processed in the thread 2 TH2, and is inserted into the task queue 2 TQ2. The task processed in the thread 2 TH2 may be deleted from the task queue 2 TQ2.

Until the thread 2 TH2 has finished all tasks to be processed, the thread 1 TH1 in state Suspend (SUS) may not be executed by the processor 110.

After one task is deleted, the thread 2 TH2 in state Run (R) may return a subsequent task after processing a task, which has the time count TC less than 2, from among the remaining tasks in the task queue 2 TQ2. The returned task has the time count TC of 2. The returned task is scheduled to be processed in the thread 3 TH3, and is inserted into the task queue 3 TQ3. The task processed in the thread 2 TH2 may be deleted from the task queue 2 TQ2. Because the thread 2 TH2 has processed all tasks having the time count TC less than 2 among tasks stored in the task queue 2 TQ2, the thread 2 TH2 may transition from state Run (R) to state Wait (W).

The thread 3 TH3 and the thread 4 TH4, each of which is in state Run (R), may process tasks having the time count TC less than 2 among tasks stored in the task queue 3 TQ3 and the task queue 4 TQ4, respectively. As a result of processing the tasks distributed by the thread 3 TH3 and the thread 4 TH4, a task to be executed in the thread 3 TH3 is inserted into the task queue 3 TQ3, and two tasks to be executed in the thread 4 TH4 are inserted into the task queue 4 TQ4. Tasks that have been processed by the thread 3 TH3 and the thread 4 TH4 may be deleted from the task queue 3 TQ3 and the task queue 4 TQ4, respectively. Because the thread 3 TH3 and the thread 4 TH4, each of which is in state Run (R), have respectively executed tasks, which have the time count TC less than 2, from among tasks inserted into the task queue 3 TQ3 and the task queue 4 TQ4, the thread 3 TH3 and the thread 4 TH4 may change from state Run (R) to state Wait (W).

The thread 1 TH1 may change from state Suspend (SUS) to state Run (R) based on the thread 2 TH2 transitioning to state Wait (W). The thread 1 TH1 in state Run (R) may execute a task having the time count TC less than 2 in the task queue 1 TQ1 and then may return two subsequent tasks. The time count TC of each of the returned tasks is 2. Among the returned tasks, one may be scheduled to be processed in the thread 1 TH1 and may be inserted into the task queue 1 TQ1, and the other thereof may be scheduled to be processed in the thread 2 TH2 and may be inserted into the task queue 2 TQ2. The task processed by the thread 1 TH1 may be deleted from the task queue 1 TQ1.

Because the thread 1 TH1 in state Run (R) has processed all tasks having the time count TC less than 2 among tasks stored in the task queue 1 TQ1, the thread 1 TH1 in state Run (R) may be changed from state Run (R) to state Wait (W).

The thread management handler 130 may increment the time count TC from 2 to 3 based on all of the plurality of threads TH1 to TH4 being in state Wait (W).

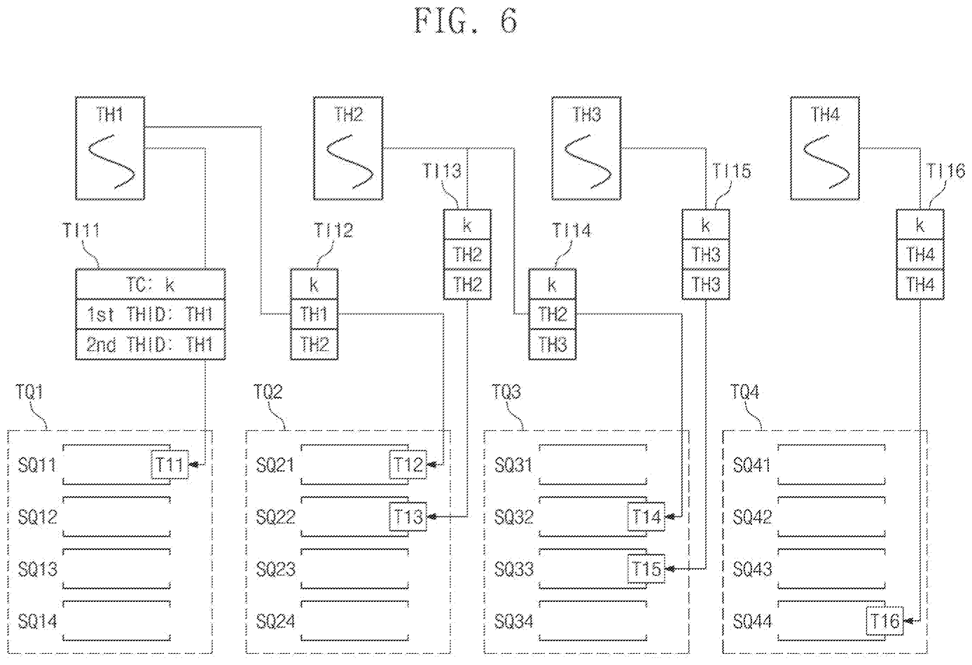

FIG. 6 is a diagram illustrating a plurality of task queues, according to an embodiment. Referring to FIG. 6, the plurality of task queues TQ1 to TQ4 may include a plurality of sub-queues SQ11 to SQ44 corresponding to the plurality of threads TH1 to TH4.

The thread management handler 130 may determine a task queue for storing the returned task from among the plurality of task queues TQ1 to TQ4 based on the second thread identifier 2nd THID included in the task information TI of the returned task ‘T’. The thread management handler 130 may determine a sub-queue for storing the returned task among a plurality of sub-queues included in the task queue determined based on the first thread identifier 1st THID included in the task information TI.

For example, the task queue 1 TQ1 may include the sub-queue 11 SQ11 to sub-queue 14 SQ14. The task queue 2 TQ2 may include the sub-queue 21 SQ21 to sub-queue 24 SQ24. The task queue 3 TQ3 may include the sub-queue 31 SQ31 to sub-queue 34 SR34. The task queue 4 TQ4 may include the sub-queue 41 SQ41 to sub-queue 44 SQ44.

When the time count TC is ‘k’, the thread 1 TH1 may return a task 11 T11 scheduled to be processed in the thread 1 TH1. In this case, the time count TC included in task information TI11 is ‘k’; the first thread identifier 1st THID corresponds to the thread 1 TH1; and the second thread identifier 2nd THID corresponds to the thread 1 TH1. In this regard, because the task 11 T11 is scheduled to be processed in the thread 1 TH1, a task queue for storing the task 11 T11 among the plurality of task queues TQ1 to TQ4 may be determined as the task queue 1 TQ1 based on the second thread identifier 2nd THID. Because the task 11 T1l is returned from the thread 1 TH1, the task 11 T11 may determine the sub-queue for storing the task 11 T11 as the sub-queue 11 SQ11 among the plurality of sub-queues SQ11 to SQ14 included in the task queue 1 TQ1 based on the first thread identifier 1st THID. The task 11 T11 may be inserted into the sub-queue 11 SQ11.

When the time count TC is ‘k’, the thread 1 TH1 may return a task 12 T12 scheduled to be processed in the thread 2 TH2. In this case, the time count TC included in task information 12 TI12 is ‘k’; the first thread identifier 1st THID corresponds to the thread 1 TH1; and the second thread identifier 2nd THID corresponds to the thread 2 TH2. Because the task 12 T12 is scheduled to be processed in the thread 2 TH2, the task 12 T12 may be inserted into the task queue 2 TQ2 among the plurality of task queues TQ1 to TQ4 based on the second thread identifier 2nd THID. Because the task 12 T12 is returned from the thread 1 TH1, the task 12 T12 may be inserted into the sub-queue 21 SQ21 among the plurality of sub-queues SQ21 to SQ24 included in the task queue 2 TQ2 based on the first thread identifier 1st THID.

When the time count TC is ‘k’, the thread 2 TH2 may return a task 13 T13 scheduled to be processed in the thread 2 TH2. In this case, the time count TC included in task information 13 TI13 is ‘k’; the first thread identifier 1st THID corresponds to the thread 2 TH2; and the second thread identifier 2nd THID corresponds to the thread 2 TH2. Because the task 13 T13 is scheduled to be executed in the thread 2 TH2, the task 12 T12 may be inserted into the task queue 2 TQ2 among the plurality of task queues TQ1 to TQ4 based on the second thread identifier 2nd THID. Because the task 13 T13 is returned from the thread 2 TH2, the task 13 T13 may be inserted into the sub-queue 22 SQ22 among the plurality of sub-queues SQ21 to SQ22 included in the task queue 2 TQ2 based on the first thread identifier 1st THID.

When the time count TC is ‘k’, the thread 2 TH2 may return a task 14 T14 scheduled to be processed in the thread 3 TH3. In this case, the time count TC included in task information 14 TI14 is ‘k’; the first thread identifier 1st THID corresponds to the thread 1 TH2; and the second thread identifier 2nd THID corresponds to the thread 3 TH3. Because the task 14 T14 is scheduled to be processed in the thread 3 TH3, the task 14 T14 may be inserted into the task queue 3 TQ3 among the plurality of task queues TQ1 to TQ4 based on the second thread identifier 2nd THID. Because the task 14 T14 is returned from the thread 2 TH2, the task 14 T14 may be inserted into the sub-queue 23 SQ23 among the plurality of sub-queues SQ31 to SQ34 included in the task queue 3 TQ3 based on the first thread identifier 1st THID.

A task 15 T15 returned from the thread 3 TH3 may be inserted into the sub-queue 33 SQ33 of the task queue 3 TQ3 based on the first thread identifier 1st THID and the second thread identifier 2nd THID included in task information 15 TI15. A task 16 T16 returned from the thread 4 TH4 may be inserted into the sub-queue 44 SQ44 of the task queue 4 TQ4 based on the first thread identifier 1st THID and the second thread identifier 2nd THID included in task information 16 TI16.

Each of the plurality of threads TH1 to TH4 may determine a sequence of processing tasks based on a plurality of corresponding sub-queues.

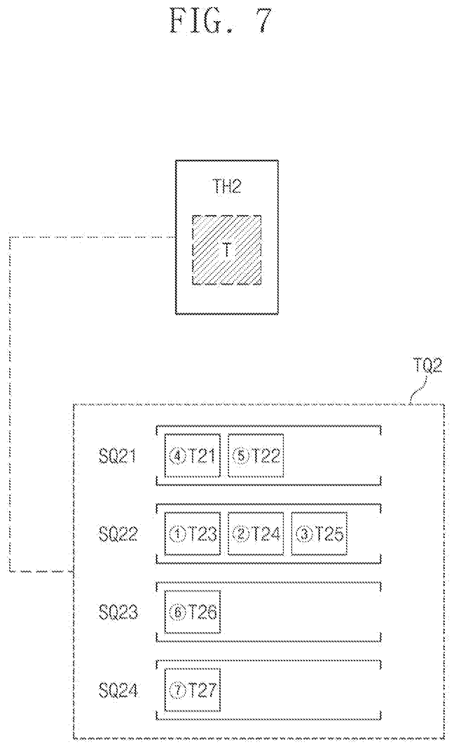

FIG. 7 is a diagram illustrating a sequence of executing tasks inserted into a task queue corresponding to a thread, according to an embodiment. Referring to FIG. 7, a thread may process a plurality of tasks T21 to T27 inserted into a corresponding task queue in a set order.

The thread 2 TH2 is one of a plurality of threads included in an application program. The thread 2 TH2 may process the tasks T21 to T27 inserted into the task queue 2 TQ2 through the processor 110 according to the policy of the application program. The tasks T21 to T27 inserted into the task queue 2 TQ2 may be stored in one of the plurality of sub-queues SQ21 to SQ24 included in the task queue 2 TQ2 depending on a thread that has returned the corresponding task.

For example, the sub-queue 21 SQ21 stores the task 21 T21 and the task 22 T22 that are returned from the thread 1 TH1. The sub-queue 22 SQ22 stores the task 23 T23, the task 24 T24, and the task 25 T25 that are returned from the thread 2 TH2. The task 26 T26 and the task 27 T27 are stored in the sub-queue 23 SQ23 and the sub-queue 24 SQ24, respectively.

As an example of a policy on thread processing of an application program, a thread may prioritize a task returned by itself over a task returned by other threads. When the thread 2 TH2 processes the plurality of tasks T21 to T27 stored in the task queue 2 TQ2, \textcircled{1} the thread 2 TH2 may process the task 23 T23 stored in the sub-queue 22 SQ22. When the processing of the task 23 T23 is completed, the task 23 T23 may be deleted from the sub-queue 22 SQ22. \textcircled{2} The thread 2 TH2 may process the task 24 T24. When the processing of the task 24 T24 is completed, the task 24 T24 may be deleted from the sub-queue 22 SQ22. After that, \textcircled{3} the thread 2 TH2 may execute the task 25 T25. When the processing of the task 25 T25 is completed, the task 25 T25 may be deleted from the sub-queue 22 SQ22. When all tasks scheduled to be processed in the sub-queue 22 SQ22 are completely processed, the thread 2 TH2 may process a task stored in one of the other sub-queues SQ21, SQ23, and SQ24. For example, the thread 2 TH2 may process tasks stored in the sub-queue 21 SQ21.

\textcircled{4} The thread 2 TH2 may process the task 21 T21. When the processing of the task 21 T21 is completed, the task 21 T21 may be deleted from the sub-queue 21 SQ21. \textcircled{5} The thread 2 TH2 may process the task 22 T22. When the processing of the task 22 T22 is completed, the task 22 T22 may be deleted from the sub-queue 21 SQ21.

After that, \textcircled{6} the thread 2 TH2 may process the task 26 T26 stored in the sub-queue 23 SQ23. When the execution of the task 26 T26 is completed, the task 26 T26 may be deleted from the sub-queue 23 SQ23. \textcircled{7} The thread 2 TH2 may process the task 27 T27 stored in the sub-queue 24 SQ24. When the processing of the task 27 T27 is completed, the task 27 T27 may be deleted from the sub-queue 24 SQ24.

The above-described processing order of tasks is an example, and the processing order of tasks may be changed according to the policy of the application program. For example, the thread 2 TH2 may process tasks by cycling through the plurality of sub-queues SQ21 to SQ24. That is, the thread 2 TH2 may process tasks in the order of the task 21 T21, the task 23 T23, the task 26 T26, the task 27 T27, the task 22 T22, the task 24 T24, and the task 25 T25.

Unlike a case where a thread returning a task corresponds to a sub-queue, the plurality of sub-queues SQ21 to SQ24 may correspond to priorities of tasks, respectively. For example, a task, which is scheduled to be executed in the thread 2 TH2 and corresponding to the highest priority, from among a plurality of tasks returned from a plurality of threads, may be stored in the sub-queue 21 SQ21. Tasks having lower priority than tasks inserted in the sub-queue 21 SQ21 may be stored in the sub-queue 22 SQ22. That is, tasks may be stored in the sub-queue 21 SQ21 to the sub-queue 24 SQ24 depending on priorities. The thread 2 TH2 may sequentially execute the task 21 T21 and the task 22 T22, which are stored in the sub-queue 21 SQ21 being a sub-queue corresponding to the highest priority. After that, the thread 2 TH2 may sequentially execute the task 23 T23, the task 24 T24, and the task 25 T25 that are stored in the sub-queue 22 SQ22. The thread 2 TH2 may sequentially execute the task 26 T26 and the task 27 T27. The number of sub-queues included in a task queue may vary according to a number of priority levels. For example, when priorities are managed to have five levels, the number of sub-queues may be determined to be five.

A plurality of task queues and a plurality of sub-queues may be implemented in various ways. For example, a plurality of task queues and a plurality of sub-queues may be implemented in a two-dimensional array. In this case, the first thread identifier and second thread identifier may be used as the index of a 2D array. A plurality of task queues and a plurality of sub-queues may be implemented as a priority queue as well as a FIFO.

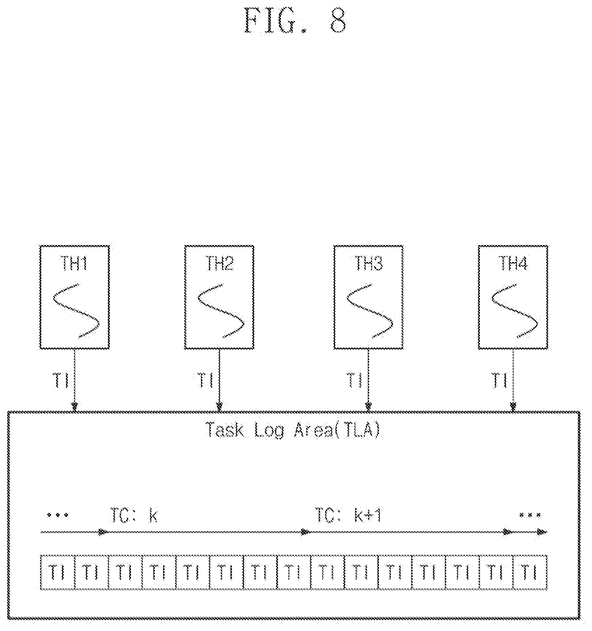

FIG. 8 is a diagram illustrating an operation, in which each of a plurality of threads records task information of a task processed in a task log area, according to an embodiment. Referring to FIG. 8, the memory 120 may include a task log area TLA for storing the task information TI.

The plurality of threads TH1 to TH4 may write the task information TI of the processed task in the task log area TLA. In this case, the task information TI delivered from the plurality of threads TH1 to TH4 may be sequentially written based on the time count TC.

The plurality of threads TH1 to TH4 may be executed by a processor, and the plurality of threads TH1 to TH4 may process all tasks to be processed. When the execution is completed, each of the plurality of threads TH1 to TH4 switches from a run state to a wait state. When all of the plurality of threads TH1 to TH4 are in wait states, the time count TC is incremented. All of the plurality of threads TH1 to TH4 are simultaneously switched from wait states to run states. Each of the plurality of threads TH1 to TH4 may process tasks having the time count TC less than the incremented time count TC. When the processing of the assigned task is completed, the plurality of threads TH1 to TH4 may store task information corresponding to the processed task in the task log area TLA. Accordingly, tasks returned when the time count TC is ‘k−1’ are processed when the time count TC is ‘k’. The task information TI corresponding to the processed task is recorded in the task log area TLA when the time count TC is ‘k’. Tasks returned when the time count TC is ‘k’ are processed when the time count TC is ‘k+1’. When the time count TC is ‘k+1’, task information corresponding to the processed task is recorded in the task log area TLA. In this way, a plurality of tasks processed by the plurality of threads TH1 to TH4 may have sequential elements based on the time count TC. The task information TI recorded in the task log area TLA may also have sequential elements based on a time count. The task information TI stored in the task log area TLA may be stored and managed in a non-volatile memory.

An operation of an application program may be easily analyzed through the task information TI stored sequentially in the task log area TLA. Moreover, because a flow is identified in which the plurality of threads TH1 to TH4 execute to concurrently process tasks, the task information TI stored in the task log area TLA may be applied to white box testing for the application program.

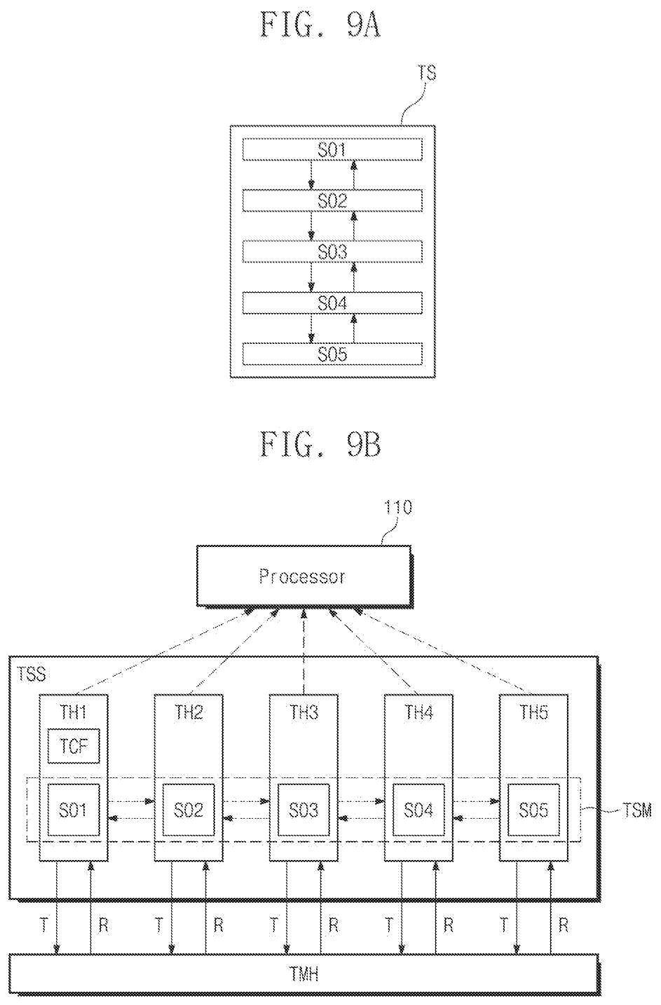

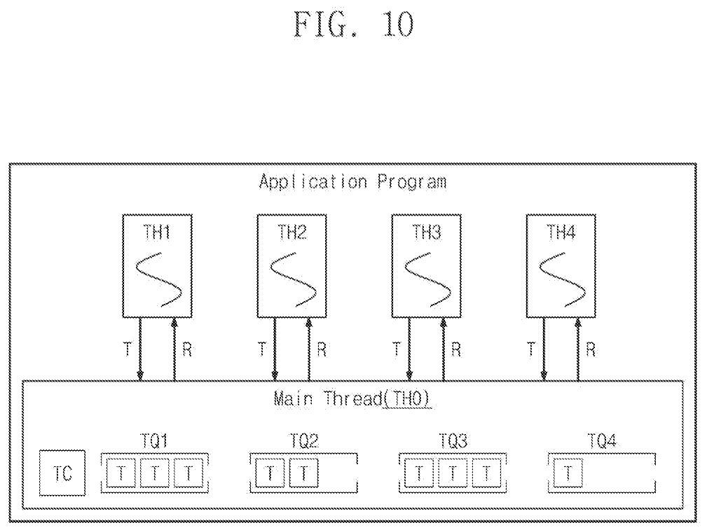

FIGS. 9A and 9B are diagrams illustrating a target system and a target system simulator, according to an embodiment. Referring to FIGS. 9A and 9B, a plurality of threads TH1 to TH5 may correspond to a plurality of system objects SO1 to SO5 of a target system TS, respectively.

An application program according to an embodiment may be a target system simulator TSS generated by modeling the target system TS. The target system simulator TSS may be used to predict an operation of the target system TS or to analyze a fault that may occur in the target system TS.

It is assumed that the target system TS includes the plurality of system objects SO1 to SO5. Each of the plurality of system objects SO1 to SO5 is a configuration that performs a function of the target system TS. Each of the plurality of system objects SO1 to SO5 may be executed in parallel. The plurality of system objects SO1 to SO5 may exchange data with each other.

For example, the target system TS may correspond to a storage device for storing data.

The system object 1 SO1 may correspond to a host driver among components constituting a storage device. The host driver may allow the storage device to communicate with an operating system of a host, and may manage data transfer between the storage device and the host.

The system object 2 SO2 may correspond to a host interface layer (HIL) among configurations constituting the storage device. The host interface layer is firmware of the storage device. The host interface layer converts commands received from the host driver into commands capable of being used by the controller.

The system object 3 SO3 may correspond to a flash translation layer (FTL). The flash translation layer is firmware of the storage device and manages the mapping between logical addresses used by the host and physical addresses used in a NAND flash memory.

The system object 4 SO4 may correspond to a flash interface layer (FIL). The flash interface layer is firmware of the storage device and manages communication between a controller and the NAND flash memory.

The system object 5 SO5 may correspond to the controller and the NAND flash memory.

The controller may read data from the NAND flash memory or may write data to the NAND flash memory. As a type of non-volatile memory that retains stored data even when power is cut off, the NAND flash memory stores data at the requested address depending on a command or address received from the controller, or provides data at the requested address to the controller.

The number of system objects of the target system TS in FIG. 9A and the connection structure of the system objects are examples. Also, the target system TS is not limited to a storage device, but may be various systems capable of being modeled. The number of system objects is not limited to the above descriptions. System objects may be implemented hierarchically, and various connection relationships may be applied.

A plurality of threads TH1 to TH5 included in the target system simulator TSS may correspond to the plurality of system objects SO1 to SO5, respectively. The thread 1 TH1 may correspond to the system object 1 SO1. The thread 2 TH2 may correspond to the system object 2 SO2. Likewise, the thread 3 TH3 to thread 5 TH5 may correspond to the system object 3 SO3 to system object 5 SO5, respectively. The thread 1 TH1 may implement a function of the system object 1 SO1 by processing allocated tasks. Likewise, the thread 2 TH2 to thread 5 TH5 may implement functions of the system object 2 SO2 to system object 5 OS5 by processing allocated tasks, respectively. The plurality of system objects SO1 to SO5 respectively implemented through the plurality of threads TH1 to TH5 may implement the target system model TSM obtained by modeling the target system TS.

The plurality of threads TH1 to TH5 are simultaneously set to a run state by the thread management handler 130. Threads set to run states may be executed concurrently by the processor. The plurality of threads TH1 to TH5 may perform data communication by using a shared area or by accessing a memory area of another thread.

One thread (e.g., the thread 1 TH1) among the plurality of threads TH1 to TH5 may include a test framework TF. The test framework TF may generate a test case for testing a target system model TSM, and may detect a fault in an operation of the target system model TSM based on the test case.

In the case where the target system simulator TSS has a single-thread structure, when the target system simulator TSS tests the target system model TSM, it is actually limited to detecting a fault occurring in each of the system objects SO1 to SO5 operating in parallel. In the case where the target system simulator TSS has a multi-thread structure, when the target system simulator TSS tests the target system model TSM, the intervention of the operating system OS reduces test reproducibility. Accordingly, to reproduce the same test results, there is a need to perform a plurality of tests. As the number of threads included in the target system simulator TSS increases, the test reproducibility is significantly reduced.

A computing system according to an embodiment may execute the target system simulator TSS. In this case, the plurality of threads TH1 to TH5 included in the target system simulator TSS are simultaneously changed to run states to process tasks thus distributed concurrently. A thread processing all tasks to be processed is converted into a wait state. The thread converted into the wait state is maintained in the wait state without being converted back to a run state. The thread management handler may process all tasks, which need to be processed by all threads, and then may set all threads to a run state in response to all threads converted to a wait state. Because threads executes concurrently and simultaneously to process distributed tasks, the threads may process their own tasks without waiting for preceding operations of other threads, as long as there is no interference between threads. Accordingly, in addition to a fault that occurs in a single-thread structure, it is possible to test a fault capable of being detected in the single-thread structure. Furthermore, the thread management handler may manage tasks based on a time count that is incremented in response to all threads being in a wait state. Accordingly, the reproducibility of the test for the target system model TSM may be improved in the target system simulator TSS.

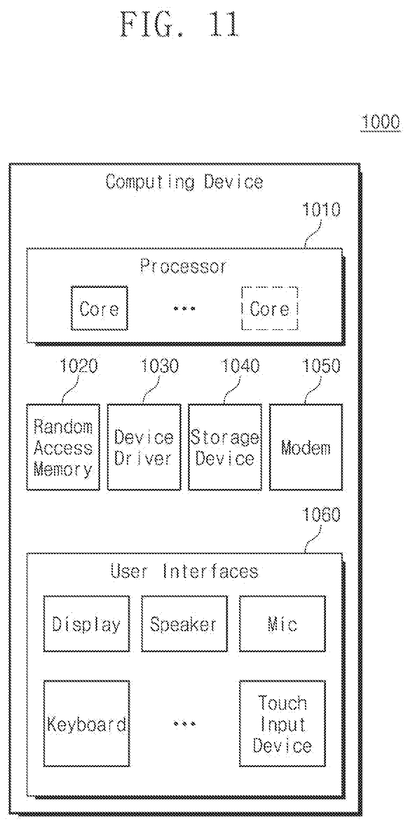

FIG. 10 is a diagram showing threads included in an application program, according to an embodiment. Referring to FIG. 10, an application program may include a main thread TH0 and the plurality of threads TH1 to TH4.

The main thread TH0 is a thread executed first when the application program is executed. The main thread TH0 may generate the plurality of threads TH1 to TH4. Also, the main thread TH0 may perform the role of the thread management handler 130 described in FIGS. 1, 2, 4, 5A to 5C, 6, 8, and 9A and 9B.

The main thread TH0 may include the plurality of task queues TQ1 to TQ4 respectively corresponding to each of the plurality of threads TH1 to TH4. The task queue 1 TQ1 corresponds to the thread 1 TH1 and stores a task to be processed by the thread 1 TH1. The task queue 2 TQ2 corresponds to the thread 2 TH2 and stores a task to be processed by the thread 2 TH2. Likewise, the task queue 3 TQ3 and the task queue 4 TQ4 store tasks to be processed by the thread 3 TH3 and the thread 4 TH4, respectively.

The tasks stored in the plurality of task queues TQ1 to TQ4 may include task information. The task information may include the time count TC managed by the main thread TH0 when a task is returned, the first thread identifier 1st THID corresponding to an identifier of a thread returning the task, and the second thread identifier 2nd THID corresponding to an identifier to be processed by the thread. The plurality of threads TH1 to TH4 may return a subsequent task after processing the distributed task. The returned task ‘T’ may be delivered to the main thread TH0.

The main thread TH0 may detect states of the plurality of threads TH1 to TH4 based on a thread control block. The main thread TH0 may increment the time count TC based on all of the plurality of threads TH1 to TH4 being in a wait state. Moreover, the main thread TH0 may set all of a plurality of threads TH1 to TH4 to state Run (R) based on all of the plurality of threads TH1 to TH4 being in a wait state. Threads in state Run (R) may process tasks having the time count TC less than the incremented time count TC among the tasks stored in the corresponding task queue. The thread that has completed processing a task having the time count TC less than the incremented time count TC may transition from a run state to a wait state.

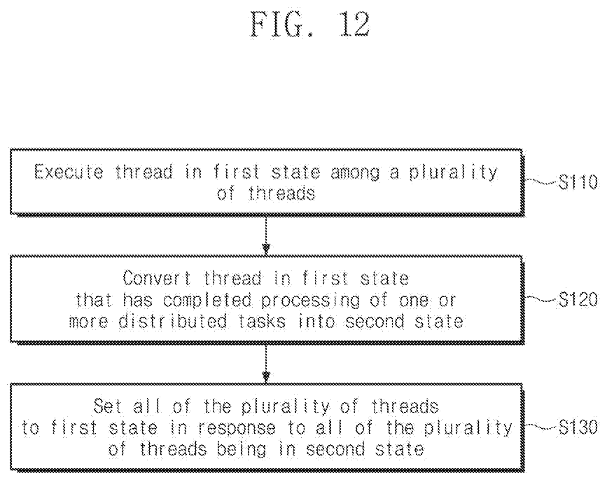

FIG. 11 is a diagram illustrating a computing device. Referring to FIG. 11, a computing device 1000 includes a processor 1010, a random access memory 1020, a device driver 1030, a storage device 1040, a modem 1050, and user interfaces 1060.

The processor 1010 may include one or more cores. The processor 1010 may execute an application program by allocating resources of the cores to a plurality of threads. The processor may be at least one general-purpose processor such as a central processing unit (CPU) or an application processor (AP). The processor 1010 may also be a special purpose processor such as a neural processing unit, a neuromorphic processor, or a graphics processing unit.

The random access memory 1020 may be used as a working memory of the processor 1010 and may be used as a main memory or a system memory of the computing device 1000. The random access memory 1020 may include a volatile memory such as a dynamic random access memory or a static random access memory or a nonvolatile memory such as a phase-change random access memory, a ferroelectric random access memory, a magnetic random access memory, or a resistive random access memory.

At the request of the processors 1010, the device driver 1030 may control the following peripheral devices: the storage device 1040, the modem 1050, and the user interfaces 1060. The storage device 1040 may include a stationary storage device such as a hard disk drive or a solid state drive, or a removable storage device such as an external hard disk drive, an external solid state drive, or a removable memory card.

The modem 1050 may provide remote communication with an external device of the computing device 1000. The modem 1050 may perform wired or wireless communication with the external device.

The user interfaces 1060 may receive information from the user and may provide information to the user. The user interfaces 1060 may include at least one user output interface such as a display or a speaker, and at least one user input interface such as a mouse, a keyboard, or a touch input device.

The computing device 100 of FIG. 1 may correspond to the computing device 1000 of FIG. 11. The processor 110 of FIG. 1 may correspond to the processor 1010 of the computing device 1000. The memory 120 of FIG. 1 may correspond to the random access memory 1020 of the computing device 1000. An application program may be stored in the storage device 1040 and may be loaded onto the random access memory 1020 by the processor 1010.

FIG. 12 is a flowchart illustrating a method for scheduling a plurality of threads, according to an embodiment. According to an embodiment, the method for scheduling a plurality of threads may include operation S110 of executing a thread in a first state (e.g., run state) corresponding to an active state among the plurality of threads included in an application program. Operation S110 may be performed by the processor 110 of the computing device 100.

According to an embodiment, the method for scheduling the plurality of threads may include operation S120 of converting the thread in the first state, which has completed processing of at least one distributed task, into a task in a second state corresponding to a wait state. Operation S120 may be performed by the processor 110 of the computing device 100.

According to an embodiment, the method for scheduling the plurality of threads may include operation S130 of setting the plurality of threads to the first state in response to all of the plurality of threads being in the second state. Operation S130 may be performed by a thread management handler of the computing device 100 or the main thread TH0 of the application program.

According to an embodiment, the method for scheduling the plurality of threads may include incrementing a time count in response to all of the plurality of threads being in the second state.

In this case, the executing (S110) of the thread in the run state may include processing tasks corresponding to a time count less than the incremented time count.

The executing (S110) of the thread in the run state may include returning at least one new task when the threads in the first state complete processing of a distributed task.

In this case, according to an embodiment, the method for scheduling a plurality of threads may further include determining a task queue for storing the new task, among a plurality of task queues, based on a thread returning the new task, and storing the new task in the determined task queue.

In this case, each of the plurality of task queues may include a plurality of sub-queues respectively corresponding to the plurality of threads. The storing of the new task in the determined task queue may include determining a sub-queue for storing the new task, from among sub-queues included in the task queue, based on the thread returning the new task, and storing the new task in the determined sub-queue.

The executing (S110) of the thread in the first state may include determining whether interference occurs between first and second threads among the plurality of threads, determining the first thread has a higher priority than the second thread, converting the second thread from the first state to a third state corresponding to a suspend state based on the determination, and converting the second thread from the third state to the first state based on the first thread converted from the first state to the second state. The second thread converted to the first state may be executed by the processor 110 of the computing device 100, and may be converted to the second state when processing of at least one distributed task is completed.

The above description refers to detailed examples for carrying out embodiments. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope as set forth in the following claims.

In accordance with an embodiment, according to the computing device and scheduling method for executing a plurality of threads, reproducibility may be guaranteed when an application program of a multi-thread structure is executed.

In some embodiments, each of the components represented by a block, including those illustrated in FIGS. 1, 2, 9B and 11, may be implemented as various numbers of hardware, software and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may include a module, a program, or a part of code, which contains one or more executable instructions for performing specified logic functions, and executed by one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A computing device comprising:
a memory configured to load an application program comprising a plurality of threads;
a processor configured to concurrently execute threads that are in a first state, and to convert a thread, which completes processing of at least one task distributed among the plurality of threads, from among the plurality of threads, from the first state into a second state, wherein the first state corresponds to an activated state in which a thread processes the at least one task, and the second state corresponds to a wait state; and
a thread management processor configured to set all of the plurality of threads to the first state based on all of the plurality of threads being in the second state.

2. The computing device of claim 1, wherein the thread management processor comprises a plurality of task queues respectively corresponding to the plurality of threads, and
wherein the plurality of task queues are configured to store at least one returned task obtained from the plurality of threads.

3. The computing device of claim 2, wherein the thread management processor is further configured to increment a current time count based on all of the plurality of threads being in the wait state.

4. The computing device of claim 3, wherein the at least one returned task comprises task information indicating a returned time count corresponding to when the at least one returned task is returned.

5. The computing device of claim 4, wherein the processor is further configured to convert a thread, from among the plurality of threads, which completes processing of all tasks stored therein that have a time count less than the current time count into the second state.

6. The computing device of claim 2, wherein each of the plurality of task queues comprises a plurality of sub-queues respectively corresponding to the plurality of threads.

7. The computing device of claim 6, wherein each of the at least one returned task comprises task information having a first thread identifier, which is an identifier of a source thread, and a second thread identifier, which is an identifier of a destination thread, and
wherein the thread management processor is further configured to identify a task queue for storing each of the at least one returned task among the plurality of task queues based on the second thread identifier, and identify a sub-queue for storing each of the at least one returned task among the plurality of sub-queues included in the task queue determined based on the first thread identifier.

8. The computing device of claim 7, wherein the thread management processor is further configured to control each of the plurality of threads to identify a sequence of processing tasks based on the plurality of sub-queues respectively corresponding to the plurality of threads.

9. The computing device of claim 1, wherein the memory further comprises a task log area, and
wherein the thread management processor is further configured to control each of the plurality of threads to sequentially write task information of a processed task in the task log area.

10. The computing device of claim 1, wherein, the thread management processor is further configured to, based on interference occurring between a first thread and a second thread that has a lower priority than the first thread, convert the second thread to a third state corresponding to a suspend state.

11. The computing device of claim 10, wherein the thread management processor is further configured to convert the second thread from the third state to the first state based on the first thread being converted into the second state.

12. A computing device comprising:
a memory configured to load an application comprising a main thread and a plurality of threads; and
a processor configured to concurrently execute threads that are in a first state, and to convert a thread, which completes processing of at least one task distributed among the plurality of threads, from among the plurality of threads, from the first state into a second state, wherein the first state corresponds to an activated state in which a thread processes at least one task, and the second state corresponds to a wait state,
wherein the processor is further configured to control the main thread to convert all of the plurality of threads to the first state based on all of the plurality of threads being in the second state.

13. The computing device of claim 12, wherein the main thread comprises a plurality of task queues respectively corresponding to the plurality of threads, and the processor is further configured to control the main thread to store at least one task returned from each of the plurality of threads in a corresponding task queue among the plurality of task queues.

14. The computing device of claim 13, wherein the processor is further configured to control:
the main thread to increment a current time count based on all of the plurality of threads being in the second state, and
the plurality of threads to process tasks, which are returned based on a time count of a corresponding task being less than the current time count.

15. A method comprising:
executing a thread in a first state among a plurality of threads included in an application program, wherein the first state corresponds to an activated state in which a thread processes at least one task distributed among the plurality of threads;
converting the thread from the first state into a second state based on the thread completing processing of at least one distributed task, wherein the second state corresponds to a wait state; and
setting all of the plurality of threads to the first state based on all of the plurality of threads being in the second state.

16. The method of claim 15, further comprising incrementing a current time count based on all of the plurality of threads being in the second state,
wherein the executing of the thread in the first state comprises processing tasks corresponding to a time count less than the current time count.

17. The method of claim 15, wherein the executing of the thread in the first state comprises returning at least one new task based on the thread in the first state completing processing of the at least one distributed task.

18. The method of claim 17, further comprising:
determining a task queue for storing the at least one new task among a plurality of task queues based on a thread returning the at least one new task; and
storing the at least one new task in the determined task queue.

19. The method of claim 18, wherein each of the plurality of task queues includes a plurality of sub-queues respectively corresponding to the plurality of threads, and
wherein the storing of the at least one new task in the determined task queue comprises:
determining a sub-queue for storing the at least one new task among sub-queues included in the task queue based on the thread returning the at least one new task; and
storing the at least one new task in the determined sub-queue.

20. The method of claim 15, wherein the executing of the thread in the first state comprises:
determining whether interference occurs between a first thread and a second thread of a lower priority than the first thread, among the plurality of threads;
converting the second thread from the first state to a third state based on the determining, the third state corresponding to a suspend state; and
converting the second thread from the third state to the first state based on the first thread being converted from the first state to the second state.
